(19) United States
(12) Patent Application Publication
(10) Pub. No.: US 2023/0005693 A1
(43) Pub. Date: Jan. 5, 2023

(54) FUSE

(71) Applicant: Pacific Engineering Corporation, Gifu (JP)

(72) Inventors: Hironori Shimizu, Gifu (JP); Hiroki Ishinaga, Gifu (JP)

(21) Appl. No.: 17/781,373

(22) PCT Filed: Dec. 4, 2020
(86) PCT No.: PCT/JP20/45198

§ 371 Date: May 31, 2022

(30) Foreign Application Priority Data
Dec. 12, 2019 (JP) 2019-224287

(51) Int. Cl. H01H 85/175; H01H 85/20

(52) U.S. Cl. CPC H01H 85/175; H01H 85/203; H01H 2231/026

(57) ABSTRACT

The present application invention provides a fuse capable of saving space inside a casing even when the casing includes a plurality of fusion parts arranged side by side. A fuse includes: a fuse element including a fusion part provided between a pair of terminal portions; and a casing configured to house a part of the fuse element while causing the terminal portions to protrude outward. Two or more of the fusion parts are arranged in a lateral direction X orthogonal to a terminal portion direction Y connecting the terminal portions and connected to the terminal portions. The casing includes two casing split pieces configured to house the fuse element to sandwich the fuse element. The respective casing split pieces are fixed to each other by a frame-shaped fixing member configured to make one round of a periphery of the respective casing split pieces. A housing space N1 of the casing has a maximum width L1 in the vertical direction Z narrower than a maximum width L2 in the lateral direction X.

### PRIORITY CLAIM

This application is a U.S. national phase of International Patent Application No. PCT/JP20/45198 filed Dec. 4, 2020; which claims the benefit of priority from Japan Patent Application No. 2019-224287 filed Dec. 12, 2019, the contents of which are incorporated herein by reference.

### FIELD OF THE INVENTION

The present application invention relates to a fuse mainly used in a vehicle electric circuit or the like, and more particularly to a fuse that houses a fuse element in a casing.

### BACKGROUND OF THE INVENTION

Conventionally, fuses have been used to protect electric circuits mounted on vehicles or the like and various electric components connected to the electric circuits. Specifically, when an unintended overcurrent flows in an electric circuit, a fusion part of a fuse element built in the fuse is fused by heat generated due to the overcurrent, which protects various electric components from having excessive current flowing through them.

Then, the fuse has various types according to the application, and for example, a fuse described in Patent Literature 1 for protecting from a relatively large overcurrent is known.

The fuse described in Patent Literature 1 is of a type in which a fuse element is housed inside a tubular casing, and includes a pair of terminal portions and a fuse element including a fusion part provided between the terminal portions. In addition, when the capacity of the fuse is increased, it is necessary to increase the size of the casing so that a plurality of fusion parts are connected in parallel between the terminal portions and the plurality of fusion parts arranged in parallel can be housed. Since this casing has a tubular shape, it is necessary to increase the diameter in order to house the plurality of fusion parts. However, although a space for enclosing an arc-extinguishing material for extinguishing the arc generated from the fusion part is required inside the casing, in the casing having a large diameter, there is an extra space more than a space required for enclosing the arc-extinguishing material, leading to waste of space.

### CITATIONS LIST

### Patent Literature

Patent Literature 1: Japanese Patent Application Laid-Open No. 2018-26202

### SUMMARY OF THE INVENTION

### Technical Problems

Therefore, the present application invention provides a fuse capable of saving space inside a casing even when the casing includes a plurality of fusion parts arranged side by side.

### Solutions to Problems

In order to solve the above problems, a fuse of the present application invention includes: a fuse element including a fusion part provided between a pair of terminal portions; and a casing configured to house a part of the fuse element while causing the terminal portions to protrude outward. Two or more of the fusion parts are arranged in a lateral direction orthogonal to a terminal portion direction connecting the terminal portions and connected to the terminal portions. The casing includes two casing split pieces configured to house the fuse element so as to sandwich the fuse element. The respective casing split pieces are fixed to each other by a frame-shaped fixing member configured to make one round of a periphery of the respective casing split pieces. A housing space of the casing has a maximum width in the vertical direction narrower than a maximum width in the lateral direction.

According to the above characteristics, since the maximum width in the vertical direction of the housing space is narrower than the maximum width in the lateral direction, the space in the vertical direction of the housing space of the casing can be made smaller than that in the conventional case, and an extra space can be omitted. In addition, the casing split pieces are fixed to each other by the frame-shaped fixing member that makes one round of the periphery of the respective casing split pieces, so that it is possible to strongly withstand the gas pressure from the inside to the outside of the casing split pieces, and the casing is prevented from being damaged.

Furthermore, in the fuse of the present application invention, the frame-shaped fixing member fixes the respective casing split pieces to each other so as to surround the terminal portions from the terminal portion direction.

According to the above characteristics, in the casing portion through which the terminal portions of the fuse element penetrates, the fixing force between the casings is prevented from weakening, and the casing is prevented from being damaged by the gas pressure.

Furthermore, in the fuse of the present application invention, the frame-shaped fixing member has a maximum width in the lateral direction larger than a maximum width in the vertical direction.

According to the above characteristics, since the frame-shaped fixing member has a structure extending in the lateral direction, it is possible to surround and fix a wider range along the lateral direction in a portion (for example, the bottom wall) of the casing to which the gas pressure is strongly applied, whereby the casing is more effectively prevented from being damaged by the gas pressure.

Furthermore, in the fuse of the present application invention, the frame-shaped fixing member has an elliptical shape and has a shape corresponding to a portion of a periphery of respective casing split pieces configured to fix the frame-shaped fixing member.

According to the above characteristics, since a gap is less likely to be generated between a part of the periphery of the casing split pieces and the frame-shaped fixing member, a portion where a fixing force to the casing split pieces by the frame-shaped fixing member is locally weakened is less likely to be generated. As a result, this prevents the casing from being damaged by the gas pressure more effectively.

Furthermore, in the fuse of the present application invention, the terminal portions and the fusion part are integrally formed of an identical material.

According to the above characteristics, the fuse element can be easily manufactured, and the fusion part and the terminal portions can be reliably electrically connected.

Furthermore, in the fuse of the present application invention, the fusion part has a smaller plate thickness than another portion of the fuse element.

According to the above characteristics, it is easy to form the fusion part and to machine the peripheral member.

### Advantageous Effects of Invention

As described above, according to the fuse of the present application invention, it is possible to save the space inside the casing even when the casing includes a plurality of fusion parts arranged side by side.

### BRIEF DESCRIPTION OF THE DRAWINGS

Preferred and alternative examples of the present invention are described in detail below with reference to the following drawings.

FIG. 1(a) is a plan view of a fuse element of a fuse according to a first embodiment of the present application invention in a state of being developed, and FIG. 1(b) is a plan view of the fuse element in a state of being formed by bending.

FIG. 2(a) is an overall perspective view of the fuse element formed by bending, and FIG. 2(b) is a side view of the fuse element formed by bending.

FIG. 3(a) is an overall perspective view of a casing split piece, FIG. 3(b) is a side view of the casing split piece, and FIG. 3(c) is a cross-sectional view of the casing split piece taken along line A-A.

FIG. 4(a) is an overall perspective view showing each member constituting the fuse in an exploded manner, and FIG. 4(b) is an overall perspective view showing a state in which a frame-shaped fixing member is to be attached.

FIG. 5(a) is an overall perspective view of a completed fuse, and FIG. 5(b) is a side view of the fuse.

FIG. 6 is a cross-sectional view taken along line B-B in FIG. 5(a).

FIG. 7(a) is a side view of a fuse according to a second embodiment of the present application invention, and FIG. 7(b) is a side view of a fuse according to a third embodiment of the present application invention.

### REFERENCE SIGNS LIST

100 Fuse element

110 Terminal portion

120 Fusion part

200 Casing split piece

290 Casing

300 Frame-shaped fixing member

N1 Housing space

X Lateral direction

Y Terminal portion direction

Z Vertical direction

Maximum width L1, L2

### DETAILED DESCRIPTION OF THE PREFERRED EMBODIMENT

Hereinafter, embodiments of the present application invention will be described with reference to the drawings. It should be noted that the shape, material, and the like of each member of fuses in the embodiments described below are merely examples, and are not limited thereto. It should be noted that the “terminal portion direction” described in this specification is a direction parallel to an axis connecting terminal portions at both ends of a fuse element. In addition, the “vertical direction” is a direction orthogonal to the terminal portion direction of the fuse element.

### First Embodiment

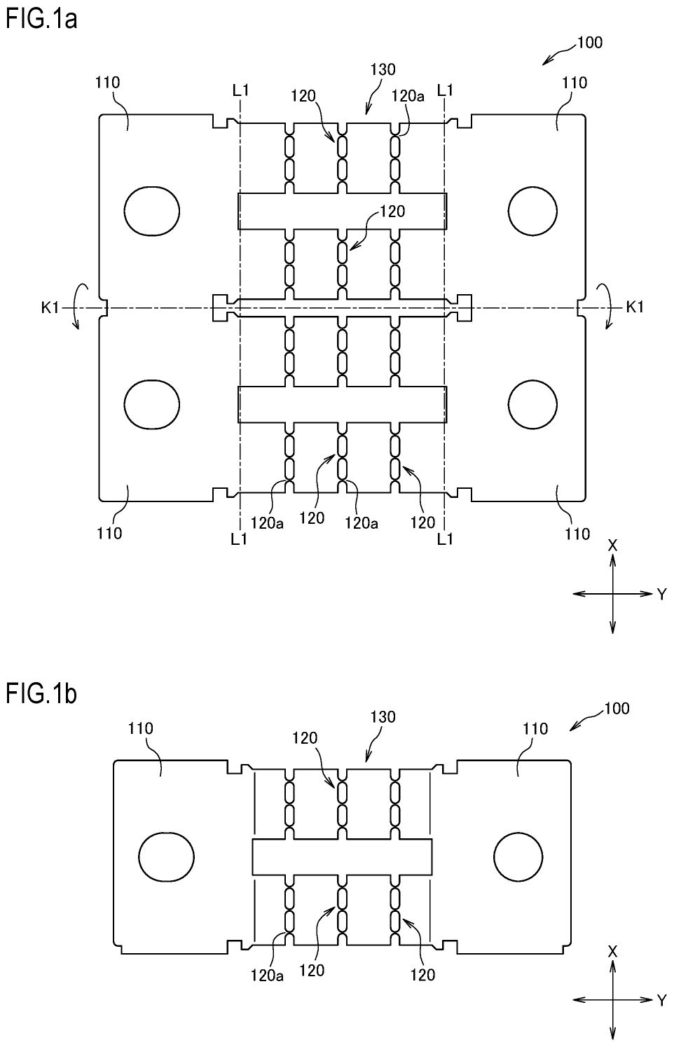

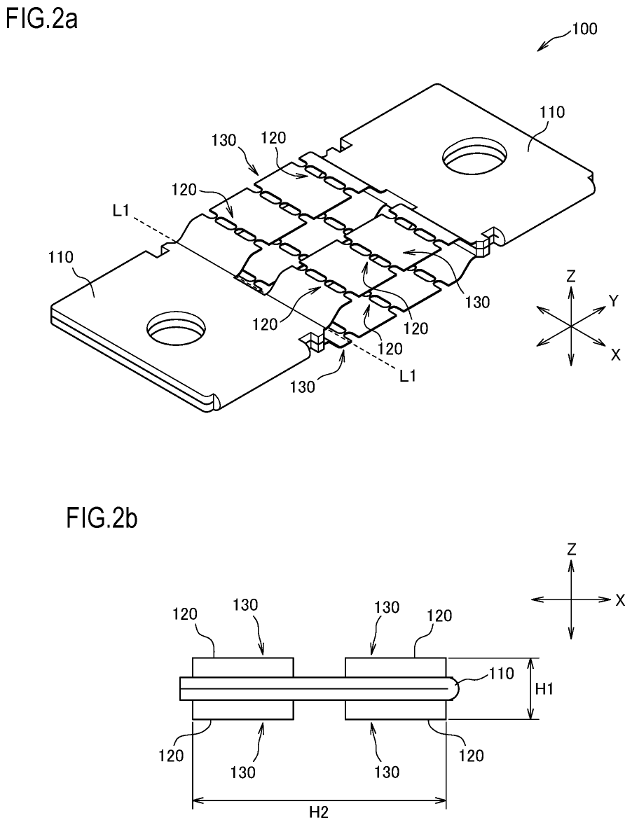

In FIG. 1, a step of manufacturing a fuse element 100 of a fuse according to a first embodiment of the present application invention will be described. FIG. 1(a) is a plan view of a state in which the fuse element 100 is developed, FIG. 1(b) is a plan view of a state in which the fuse element 100 is formed by bending, FIG. 2(a) is an overall perspective view of the fuse element 100 formed by bending, and FIG. 2(b) is a side view of the fuse element 100 formed by bending.

First, a flat plate material made of conductive metal such as copper or an alloy thereof is punched into a shape as shown in FIG. 1(a) by a pressing machine or the like. In one metal plate shaped into a predetermined shape as shown in FIG. 1(a), terminal portions 110 at both ends, a flat intermediate portion 130 between the terminal portions 110, and a plurality of fusion parts 120 in the intermediate portion 130 are formed. More specifically, the fusion part 120 includes a plurality of linear fusion places 120a having a locally narrow width by providing small holes in the intermediate portion 130, and each of the fusion places 120a generates heat and is fused to cut off an overcurrent when an unintended overcurrent flows through an electric circuit or the like. It should be noted that the fusion part 120 is not limited to including the linear fusion places 120a having a narrow width, and as long as the fusion part 120 can generate heat and be fused to cut off an overcurrent when an unintended overcurrent flows through the electric circuit or the like, the fusion part 120 can adopt any configuration such as locally disposing a metal material to be easily fused in the intermediate portion 130.

Next, as shown in FIGS. 1(a) and 1(b), the vicinity of the connecting place between the intermediate portion 130 and each of the terminal portions 110 is bent upward at a folding line L1. Then, the intermediate portion 130 comes into a state of being connected to the terminal portions 110 so as to slightly swell upward from the terminal portions 110. The folding line L1 is parallel to a direction orthogonal to the terminal portion direction Y. Furthermore, in the folding line K1 parallel to the terminal portion direction Y of the fuse element 100, the side-by-side terminal portions 110 are bent so as to vertically overlap each other. It should be noted that the terminal portion direction Y of the fuse element 100 is a direction parallel to an axis connecting the terminal portions 110 on both sides. Therefore, the folding line K1 is also parallel to the axis connecting the terminal portions 110 on both sides.

Then, the three-dimensionally bent fuse element 100 as shown in FIGS. 1(b) and 2 is completed. The fuse element 100 is in a state where two intermediate portions 130 are arranged in the lateral direction X and connected to the terminal portions 110. That is, since the two fusion parts 120 are arranged in the lateral direction X and connected to the terminal portions 110, the capacity of the fusion part increases in the entire fuse. Then, since the fusion parts 120 of the intermediate portions 130 are arranged in the lateral direction X, the width H2 in the lateral direction X is larger than the height H1 in the vertical direction Z on the terminal portions 110 side of the fuse element 100 as shown in FIG. 2(b). It should be noted that the lateral direction X is a direction orthogonal to the terminal portion direction Y. In addition, the terminal portions 110 extend along a plane defined by the lateral direction X and the terminal portion direction Y, that is, an X-Y plane. In addition, the vertical direction Z is a direction orthogonal to each of the lateral direction X and the terminal portion direction Y.

In addition, as shown in FIG. 2, the intermediate portions 130 facing each other in the vertical direction Z are configured to bulge outward with the terminal portion 110 interposed therebetween. Since the intermediate portions 130 are bent along the folding line L1 in directions separated from each other, the fusion parts 120 of the upper and lower intermediate portions 130 are less likely thermally affected by each other, and can exhibit desired fusion characteristics. It should be noted that in the fuse element 100 shown in FIGS. 1 and 2, the two intermediate portions 130 are arranged in the lateral direction X and connected to the terminal portions 110, but the present invention is not limited thereto, and three or more intermediate portions 130 may be arranged in the lateral direction X and connected to the terminal portions 110. It should be noted that when three or more fusion parts 120 are arranged in the lateral direction X and connected to the terminal portions 110, the fuse element 100 has the width H2 in the lateral direction X still larger than the height H1 in the vertical direction Z.

In addition, in FIGS. 1 and 2, since the fusion parts 120 and the terminal portions 110 of the fuse element 100 are integrally formed of the same material, the fuse element 100 can be easily manufactured, and the fusion parts 120 and the terminal portions 110 can be reliably electrically connected. It should be noted that although the fusion parts 120 and the terminal portions 110 of the fuse element 100 are integrally formed of the same material, the present invention is not limited thereto, and the intermediate portions 130 including the fusion parts 120, and the terminal portions 110 may be manufactured separately and connected to each other by welding or the like. Furthermore, the fuse element 100 is formed by punching a flat plate material made of a conductive metal, such as copper or an alloy thereof, into a shape as shown in FIG. 1(a) with a pressing machine or the like, and this plate material is one plate material in which only the plate thickness of the intermediate portions 130 including the fusion parts 120 is smaller, and the plate thickness of the terminal portions 110 is larger, that is, one plate material (deformed material) in which the thickness is not uniform, and only the plate thickness of the portions constituting the fusion parts 120 is smaller than the plate thickness of the other portions (such as the terminal portion 110). Therefore, it is not necessary to separately prepare the fusion part 120 made of a plate material having a smaller plate thickness and the terminal portion 110 made of a plate material having a larger plate thickness and weld them to each other, so that the fuse element 100 can be easily manufactured. Furthermore, it is easy to form a narrow and linear fusion place 120a because the plate thickness of the fusion part 120 is small, that is, it is easy to machine the fusion part 120 and its peripheral members (intermediate portion 130 and the like). It should be noted that although the material constituting the fuse element 100 is a material (deformed material) in which only the plate thickness of the portions constituting the fusion parts 120 is smaller than the plate thickness of the other portions (such as the terminal portions 110), the present invention is not limited thereto, and a plate material may be used in which the plate thickness of the portions constituting the fusion parts 120 is the same as the plate thickness of the other portions (such as the terminal portions 110), that is, the thickness is uniform.

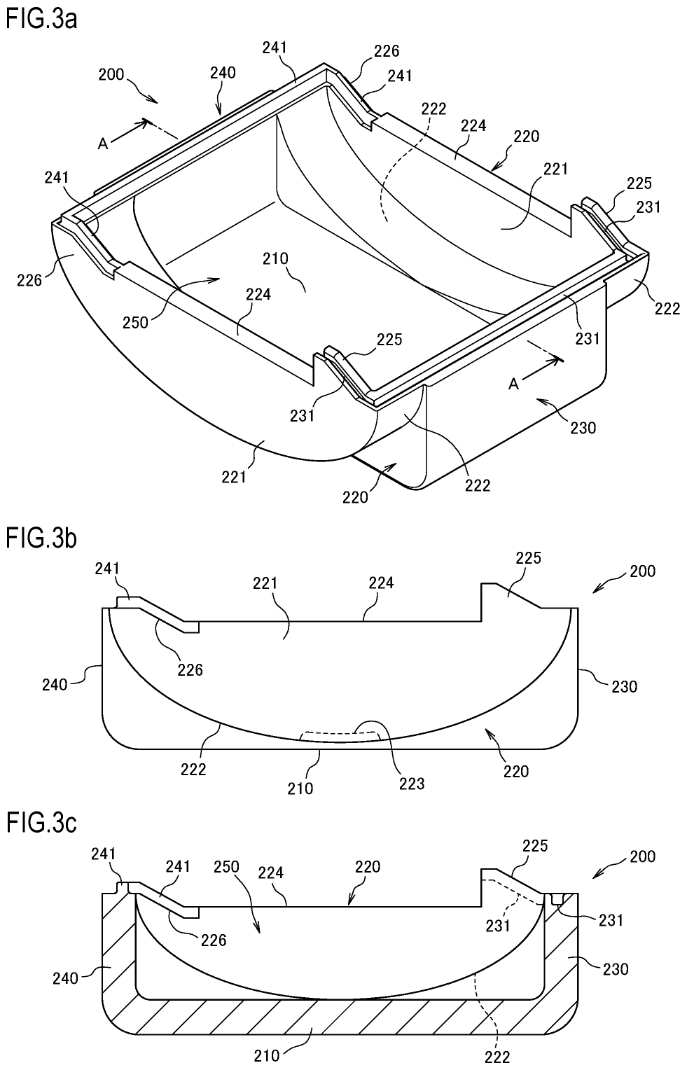

Next, a casing split piece 200 of a casing 290 that houses the fuse element 100 will be described with reference to FIG. 3. It should be noted that FIG. 3(a) is an overall perspective view of the casing split piece 200, FIG. 3(b) is a side view of the casing split piece 200, and FIG. 3(c) is a cross-sectional view of the casing split piece 200 taken along line A-A.

The casing split piece 200 is made of synthetic resin as a whole and has a substantially rectangular parallelepiped shape, and includes a bottom wall 210, side walls 220 on both sides rising from the bottom wall 210, and left and right peripheral walls 230 and 240. Then, the casing split piece 200 has the bottom wall 210 surrounded by the side walls 220, the peripheral wall 230, and the peripheral wall 240, and includes an opening 250 therein. In addition, the side walls 220 each have a substantially semicircular columnar fixing portion 221 extending laterally, and the outer surface 222 of the fixing portion 221 extends in a band shape so as to draw a semicircle along the circumferential direction of the fixing portion 221. In addition, a recessed portion 223 recessed inward is formed near the substantial center of the outer surface 222. As will be described below, a flat placement surface 224 on which the terminal portion 110 of the fuse element 100 is placed is formed on the upper side of the fixing portion 221. In addition, a protruding portion 225 protruding upward from the placement surface 224 is formed on one end side of the placement surface 224, and a recessed portion 226 recessed downward from the placement surface 224 is also formed on the other end side of the placement surface 224.

On the other hand, a fitting recessed portion 231 linearly extending toward the side walls 220 on both sides is formed at the upper end of the peripheral wall 230, and both ends of the fitting recessed portion 231 are bent and extend to the protruding portion 225 side of the fixing portion 221 of the side wall 220. In addition, a fitting protruding portion 241 linearly extending toward the side walls 220 on both sides is formed at the upper end of the peripheral wall 240 on the opposite side from the peripheral wall 230, and both ends of the fitting protruding portion 241 are bent and extend to the recessed portion 226 side of the fixing portion 221 of the side wall 220.

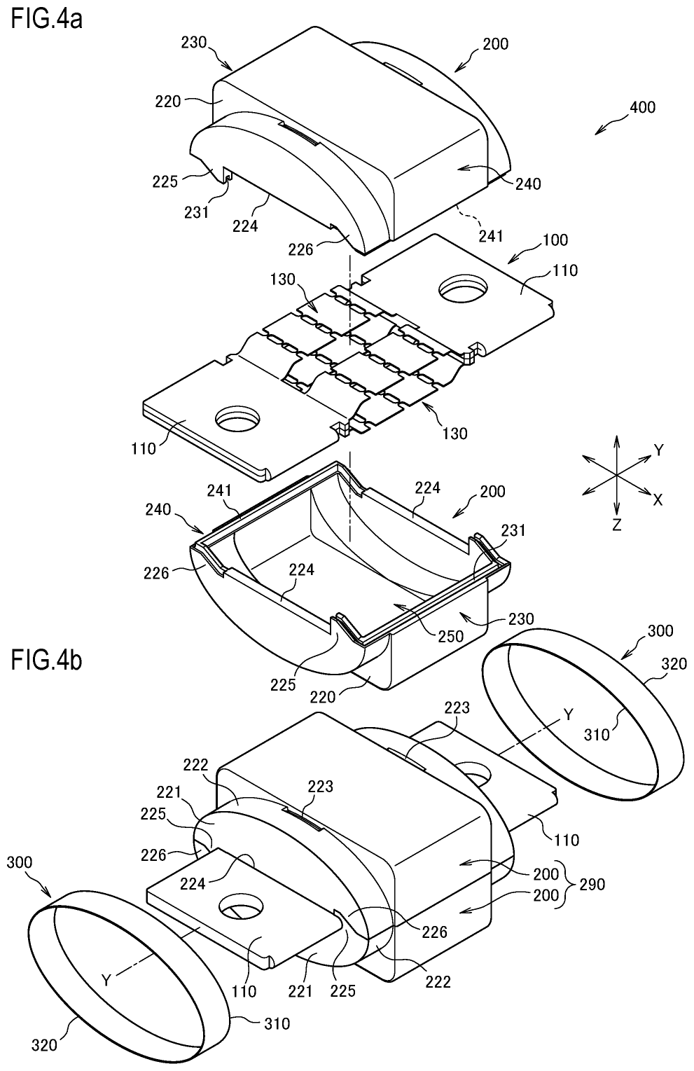

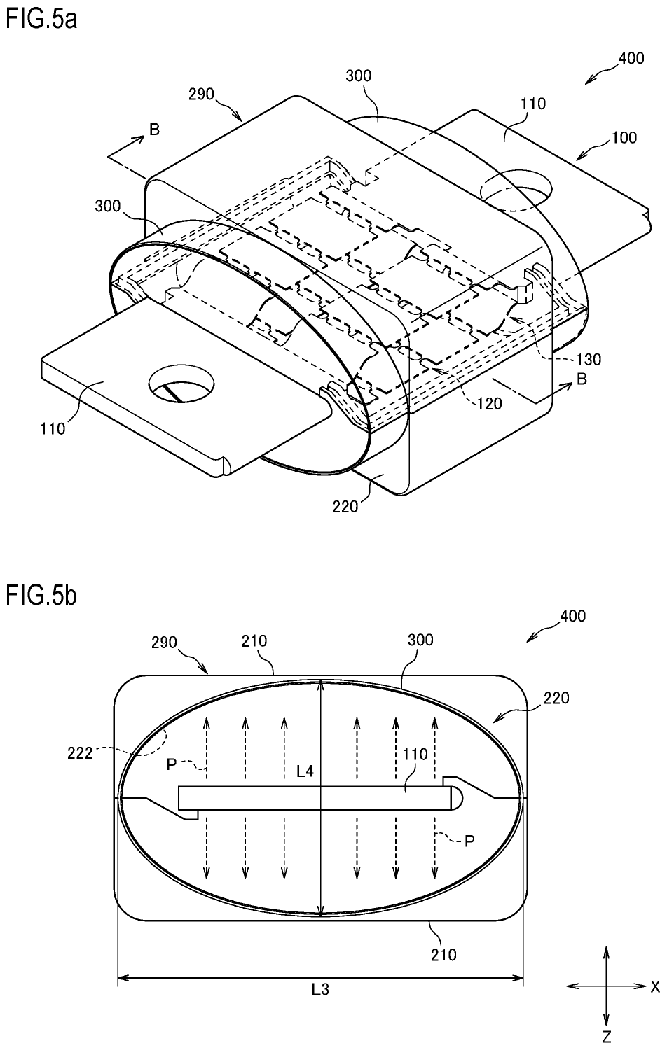

Next, a method for assembling a fuse 400 of the present application invention will be described with reference to FIGS. 4 and 5. It should be noted that FIG. 4(a) is an overall perspective view showing each member constituting the fuse 400 in an exploded manner, FIG. 4(b) is an overall perspective view showing a state in which a frame-shaped fixing member 300 is to be attached, FIG. 5(a) is an overall perspective view of the completed fuse 400, and FIG. 5(b) is a side view of the fuse 400.

As shown in FIG. 4(a), first, the casing split piece 200 is disposed with an opening 150 directed upward. Then, the respective terminal portions 110 of the fuse element 100 are placed on the placement surfaces 224 of the side walls 220 on both sides of the casing split piece 200. The intermediate portions 130 of the fuse element 100 are in a state of being housed in the opening 250 of the casing split piece 200. Next, the same casing split piece 200 as the lower casing split piece 200 is fitted from above the lower casing split piece 200 with the opening 250 directed downward.

Specifically, the placement surfaces 224 of the side walls 220 of the upper casing split piece 200 are applied toward the terminal portions 110, and the terminal portions 110 of the fuse element 100 are vertically sandwiched between the placement surfaces 224 of the upper casing split piece 200 and the placement surfaces 224 of the lower casing split piece 200. At this time, the fitting protruding portion 241 of the peripheral wall 240 of the upper casing split piece 200 is fitted into the fitting recessed portion 231 of the peripheral wall 230 of the lower casing split piece 200, and the fitting protruding portion 241 of the peripheral wall 240 of the lower casing split piece 200 is fitted into the fitting recessed portion 231 of the peripheral wall 230 of the upper casing split piece 200. Furthermore, the protruding portions 225 and the recessed portions 226 of the upper and lower casing split pieces 200 are vertically meshed with each other. Then, as shown in FIG. 4(b), the upper and lower casing split pieces 200 are assembled in a state where the fusion parts 120 are housed therein. It should be noted that the casing 290 includes the upper and lower two casing split pieces 200, but the present invention is not limited thereto, and the casing 290 may include three or more casing split pieces as long as the casing 290 is assembled in a state where the fusion parts 120 are housed inside.

Next, as shown in FIG. 4(b), the frame-shaped fixing members 300 are attached to the casing 290 so as to surround the terminal portions 110 from the terminal portion direction Y. Specifically, the terminal portions 110 are inserted into the frame-shaped fixing members 300 and then the frame-shaped fixing member 300 are moved along the terminal portion direction Y to be press-fitted into the outer surfaces 222 of the fixing portions 221 of the casing 290. The outer surfaces 222 of the upper and lower fixing portions 221 are configured to continuously make one round of the periphery of the casing split pieces 200 by assembling the upper and lower casing split pieces 200. Therefore, by press-fitting the frame-shaped fixing members 300 along the upper and lower outer surfaces 222, the upper and lower casing split pieces 200 are firmly fixed to each other by the frame-shaped fixing members 300.

It should be noted that the frame-shaped fixing members 300 each are an annular body made of metal, and have the same shape so as to correspond to the outer surfaces 222 of the fixing portions 221 of the casing 290. In addition, the frame-shaped fixing members 300 are slightly smaller than the outer surfaces 222 so that the frame-shaped fixing members 300 can be press-fitted into the outer surfaces 222 of the fixing portions 221. Furthermore, when the frame-shaped fixing members 300 are press-fitted into the outer surfaces 222 and then a part of each of the frame-shaped fixing members 300 is bent (that is, swaged) toward the recessed portion 223 of each of the outer surfaces 222, the frame-shaped fixing members 300 are less likely to be detached from the outer surfaces 222 of the casing 290. Furthermore, the diameter of the inner end 310 of each of the frame-shaped fixing members 300 is slightly larger than the diameter of the outer end 320, so that the frame-shaped fixing members 300 are easily press-fitted into the outer surfaces 222.

It should be noted that in FIG. 4, the frame-shaped fixing members 300 are attached to the casing 290 so as to surround the peripheries of the terminal portions 110 from the terminal portion direction Y, but the present invention is not limited thereto, and the frame-shaped fixing members 300 may be attached so as to surround the peripheral walls 230 and the peripheral walls 240 of the casing split pieces 200 from the lateral direction X. In addition, although the frame-shaped fixing members 300 are made of metal, the present invention is not limited thereto, and any material may be adopted as long as each of the casing split pieces 200 can be fixed to each other and can withstand the gas pressure during fusing.

Next, the assembled fuse 400 is shown in FIG. 5. As shown in FIG. 5, the fusion parts 120 of the intermediate portions 130 being a part of the fuse element 100 are housed inside by the casing 290, and the terminal portions 110 of the fuse element 100 protrude laterally from the side walls 220 of the casing 290 so as to be electrically connected to the outside.

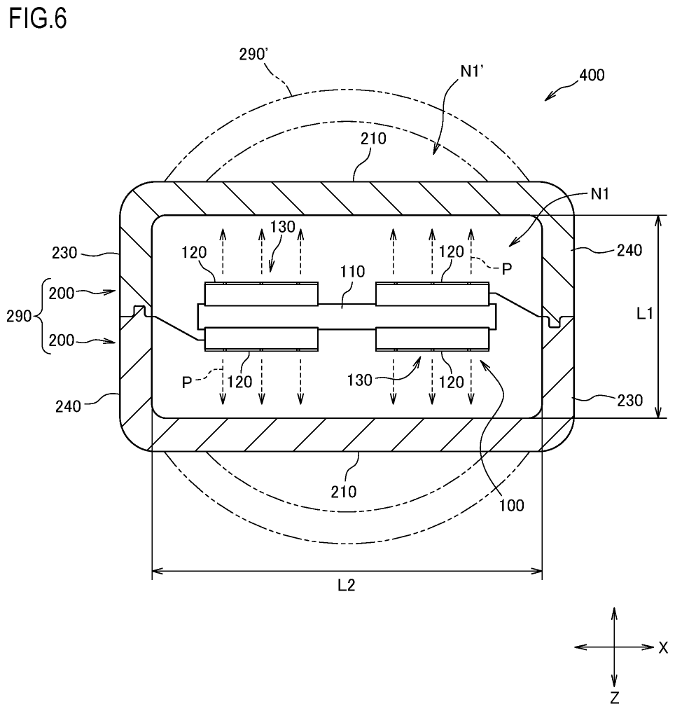

Next, an internal structure of the casing 290 of the fuse 400 will be described with reference to FIG. 6. FIG. 6 is a cross-sectional view taken along line B-B in FIG. 5(a).

As shown in FIG. 6, the inside of the casing 290 of the fuse 400 is a housing space N1, and the fusion parts 120 of the intermediate portions 130 of the fuse element 100 are housed in the housing space N1. The housing space N1 is configured by connecting the openings 250 of the upper and lower casing split pieces 200 so as to face each other. In addition, since the casing 290 has a substantially rectangular parallelepiped shape, the housing space N1 also has a substantially rectangular parallelepiped shape.

Here, a maximum width L2 of the casing 290 in the lateral direction X needs to be increased by that amount as the number of the fusion parts 120 to be arranged is increased so that a plurality of fusion parts 120 can be arranged in the lateral direction X and housed. Therefore, when the casing has a tubular shape as in the conventional case, as shown in FIG. 6, the fusion parts 120 are housed in a tubular casing 290′ having the maximum width L2 in diameter. However, although an arc-extinguishing material (not shown) for extinguishing an arc is enclosed in the housing space N1′ of the casing 290′, the housing space N1′ present in the vertical direction Z of the fusion parts 120 is larger than necessary, and in particular, there is an extra space more than the space necessary for enclosing the arc-extinguishing material, leading to waste of space. Therefore, in the fuse 400 of the present application invention, as shown in FIG. 6, a maximum width L1 of the housing space N1 in the vertical direction Z is made narrower than the maximum width L2 in the lateral direction X. Thus, the space of the housing space Ni in the vertical direction Z of the casing 290 of the present application invention can be made smaller than the space of the housing space N1′ in the vertical direction Z of the conventional casing 290′, and an extra space can be omitted. Therefore, according to the present application invention, the space inside the casing 290 can be saved.

In addition, at the time of assembling work of the fuse 400 of the present application invention, the fuse element 100 having a special shape in which two or more fusion parts 120 are arranged in the lateral direction X needs to be housed in the casing 290. Therefore, in order to further simplify the assembling work, the fuse 400 of the present application invention adopts a simple and workable configuration in which the fuse element 100 is sandwiched and housed in the vertical direction Z by the casing split pieces 200. On the other hand, in the fuse element 100 of the present application invention, since two or more fusion parts 120 are arranged in the lateral direction X, the pressure P of the gas generated when the fusion part 120 is fused due to overcurrent tends to be increased by that amount of the increased number of the fusion parts 120. Then, the respective casing split pieces 200 vertically assembled are pushed out in a direction of being separated from each other by the gas pressure P and detached, and the casing 290 may be damaged. Therefore, in the fuse 400 of the present application invention, the upper and lower casing split pieces 200 are fixed to each other by the frame-shaped fixing members 300 each of which make one round of the periphery of the respective casing split pieces 200, so that it is possible to strongly withstand the gas pressure P from the inside to the outside of the casing split pieces 200, and the casing 290 is prevented from being damaged.

In addition, in the fuse 400 of the present application invention, as shown in FIG. 4, since the respective casing split pieces 200 are fixed to each other so as to surround the terminal portions 110 from the terminal portion direction Y by the frame-shaped fixing members 300, the casing 290 is more effectively prevented from being damaged. Specifically, in order to connect the fuse 400 to an electric circuit or the like, each of the terminal portions 110 needs to protrude from the side of the casing 290. Then, since the terminal portion 110 is interposed in the portion (see, for example, the placement surface 224 of the casing split piece 200 shown in FIG. 4.) through which the terminal portion 110 penetrates, the upper and lower casing split pieces 200 cannot be directly assembled to each other, and the fixing force of the portion through which the terminal portion 110 penetrates tends to be locally weak. Therefore, in the fuse 400 of the present application invention, as shown in FIG. 4, the respective casing split pieces 200 are fixed to each other so as to surround the terminal portion 110 from the terminal portion direction Y by the frame-shaped fixing member 300, which prevents the fixing force of the portion through which the terminal portion 110 penetrates from being weakened and prevents the casing 290 from being damaged by the gas pressure.

Furthermore, in the fuse 400 of the present application invention, as shown in FIG. 5, a maximum width L3 in the lateral direction X of the frame-shaped fixing member 300 is larger than a maximum width L4 in the vertical direction Z. As shown in FIG. 6, in the fuse element 100 of the present application invention, since two or more fusion parts 120 are arranged in the lateral direction X, the pressure P of the gas generated when the fusion part 120 is fused due to overcurrent tends to be increased by that amount of the increased number of the fusion parts 120, and in particular, the gas pressure P in the vertical direction Z increases and is strongly applied to the bottom wall 210 of the casing 290 facing the plurality of fusion parts 120. Therefore, making the maximum width L3 in the lateral direction X of the frame-shaped fixing member 300 larger than the maximum width L4 in the vertical direction Z causes the frame-shaped fixing member 300 to have a structure extending in the lateral direction X, that is, a horizontally long structure. Then, since the frame-shaped fixing member 300 has a structure extending in the lateral direction X, it is possible to surround and fix a wider range along the lateral direction X in a portion (for example, the bottom wall 210) of the casing 290 to which the gas pressure P is strongly applied. This prevents the casing 290 from being damaged by the gas pressure P more effectively.

Furthermore, in the fuse 400 of the present application invention, as shown in FIG. 5(b), in a side view, the maximum width L3 of the frame-shaped fixing member 300 in the lateral direction X is larger than the maximum width L4 in the vertical direction Z, and the frame-shaped fixing member 300 has an elliptical shape. Then, a part of the periphery of the casing split piece 200 (for example, outer surface 222) fixing the frame-shaped fixing member 300 and the frame-shaped fixing member 300 have corresponding shapes so as to match with each other. Thus, the frame-shaped fixing member 300 can be easily attached to a part (outer surface 222) of the casing split piece 200, and the fuse 400 can be easily assembled. In addition, since the frame-shaped fixing member 300 has an elliptical shape and a gap is less likely to be generated between the frame-shaped fixing member and a part (outer surface 222) of the casing split piece 200, a portion where a fixing force to the casing split piece 200 by the frame-shaped fixing member 300 is locally weakened is less likely to be generated. As a result, this prevents the casing 290 from being damaged by the gas pressure more effectively.

### Second Embodiment

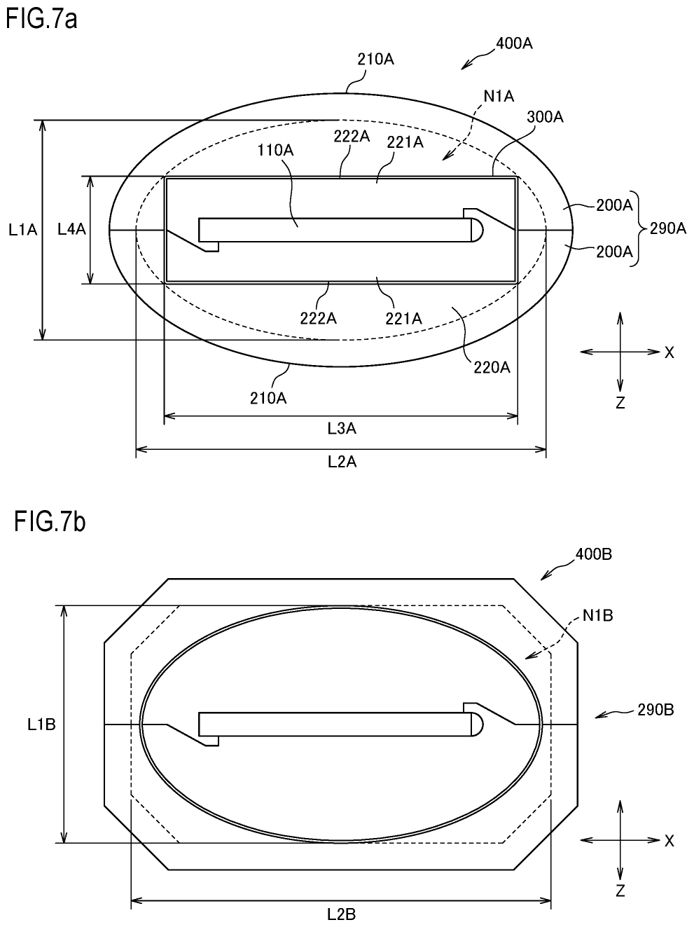

Hereinafter, a fuse 400A according to a second embodiment of the present application invention will be described with reference to FIG. 7(a). It should be noted that the fuse 400A is different from the fuse 400 according to the first embodiment only in the shape of a casing 290A and the shape of a frame-shaped fixing member 300A, and the other configurations are common to those of the fuse 400 according to the first embodiment, so that detailed description of the common configurations is omitted.

First, FIG. 7(a) shows a side view of the fuse 400A according to the second embodiment of the present application invention. The casing 290A of the fuse 400A is a cylindrical body having a substantially elliptical cross section. Then, in a housing space N1A inside the casing 290A, a maximum width L1A in the vertical direction Z is narrower than a maximum width L2A in the lateral direction X. Thus, in the fuse 400A according to the second embodiment of the present application invention, the space of the housing space N1A of the casing 290A in the vertical direction Z can be made smaller than that in the conventional case, and an extra space can be omitted. As described above, if the maximum width L1A in the vertical direction Z is narrower than the maximum width L2A in the lateral direction X in the housing space N1A inside the casing 290A, the shape of the casing 290A can be any shape such as a substantially rectangular parallelepiped or a substantially cylindrical body.

Furthermore, as shown in FIG. 7(a), in a side wall 220A of a casing split piece 200A constituting the casing 290A, a fixing portion 221A has a substantially rectangular shape in a side view, and an outer surface 222A of the fixing portion 221A for fixing a frame-shaped fixing member 300A also has a substantially quadrangular shape that makes one round of the periphery of the casing 290A. Then, the frame-shaped fixing member 300A having a substantially quadrangular shape in a side view and having a corresponding shape so as to match the outer surface 222A is press-fitted into the outer surface 222A. Thus, in the fuse 400A according to the second embodiment of the present application invention, the upper and lower casing split pieces 200A are fixed to each other by the frame-shaped fixing member 300A that makes one round of the periphery of the respective casing split pieces 200A, so that it is possible to strongly withstand the gas pressure from the inside to the outside of the casing split pieces 200A, and the casing 290A is prevented from being damaged. As described above, the frame-shaped fixing member 300A can have any shape such as a substantially elliptical shape or a substantially quadrangular shape in a side view as long as the casing split pieces 200A can be fixed to each other so that one round of the periphery of the respective casing split pieces 200A is made.

Furthermore, since the frame-shaped fixing member 300A has a maximum width L3A in the lateral direction X of the frame-shaped fixing member 300A larger than a maximum width L4A in the vertical direction Z, the frame-shaped fixing member 300A has a long structure in the lateral direction X, that is, a horizontally long structure. Then, since the frame-shaped fixing member 300A has a structure extending in the lateral direction X, it is possible to surround and fix a wider range along the lateral direction X in a portion (for example, the bottom wall 210A) of the casing 290A to which the gas pressure is strongly applied. This prevents the casing 290A from being damaged by the gas pressure more effectively.

### Third Embodiment

Hereinafter, a fuse 400B according to a third embodiment of the present application invention will be described with reference to FIG. 7(b). It should be noted that the fuse 400B is different from the fuse 400 according to the first embodiment only in the shape of a casing 290B, and the other configurations are common to those of the fuse 400 according to the first embodiment, so that detailed description of the common configurations is omitted.

FIG. 7(b) shows a side view of the fuse 400B according to the third embodiment of the present application invention. The casing 290B of the fuse 400B is a prism having a substantially octagonal cross section. Then, in a housing space NM inside the casing 290B, a maximum width L1B in the vertical direction Z is narrower than a maximum width L2B in the lateral direction X. Thus, in the fuse 400B according to the third embodiment of the present application invention, the space of the housing space NM of the casing 290B in the vertical direction Z can be made smaller than that in the conventional case, and an extra space can be omitted. As described above, in the housing space NM inside the casing 290B, if the maximum width L1B in the vertical direction Z is narrower than the maximum width L2B in the lateral direction X, the shape of the casing 290B can be any shape such as a substantially rectangular parallelepiped or a prism having a substantially octagonal cross section.

It should be noted that the fuse according to the present application invention is not limited to the above embodiments, and various modifications and combinations are possible within the scope of the claims and the scope of the embodiments, and these modifications and combinations are also included in the scope of rights.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

In the claims:

1. A fuse comprising:
a fuse element including a fusion part provided between a pair of terminal portions; and
a casing configured to house a part of the fuse element while causing the terminal portions to protrude outward,
wherein two or more of the fusion parts are arranged in a lateral direction orthogonal to a terminal portion direction connecting the terminal portions and connected to the terminal portions,
wherein the casing includes two casing split pieces configured to house the fuse element to sandwich the fuse element,
wherein the respective casing split pieces are fixed to each other by a frame-shaped fixing member configured to make one round of a periphery of the respective casing split pieces, and
wherein a housing space of the casing has a maximum width in a vertical direction narrower than a maximum width in the lateral direction.

2. The fuse according to claim 1, wherein the frame-shaped fixing member fixes the respective casing split pieces to each other to surround one of the terminal portions from the terminal portion direction.

3. The fuse according to claim 2, wherein the frame-shaped fixing member has a maximum width in the lateral direction larger than a maximum width in the vertical direction.

4. The fuse according to claim 3, wherein the frame-shaped fixing member has an elliptical shape and has a shape corresponding to a portion of a periphery of respective casing split pieces configured to fix the frame-shaped fixing member.

5. The fuse according to claim 1, to wherein the terminal portions and the fusion parts are integrally formed of an identical material.

6. (canceled)

7. The fuse according to claim 2, wherein the terminal portions and the fusion parts are integrally formed of an identical material.

8. The fuse according to claim 3, wherein the terminal portions and the fusion parts are integrally formed of an identical material.

9. The fuse according to claim 4, wherein the terminal portions and the fusion parts are integrally formed of an identical material.

10. The fuse according to claim 1, wherein the fusion part has a smaller plate thickness than another portion of the fuse element.

11. The fuse according to claim 2, wherein the fusion part has a smaller plate thickness than another portion of the fuse element.

12. The fuse according to claim 3, wherein the fusion part has a smaller plate thickness than another portion of the fuse element.

13. The fuse according to claim 4, wherein the fusion part has a smaller plate thickness than another portion of the fuse element.

14. The fuse according to claim 5, wherein the fusion part has a smaller plate thickness than another portion of the fuse element.
